(19) United States
(12) Patent Application Publication
(10) Pub. No.: US 2008/0190947 A1
(43) Pub. Date: Aug. 14, 2008

(54) Portable Oxygen Bottle Holder

(75) Inventor: Elroy E. Bourgraf, Maineville, OH (US)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: Ferno-Washington, Inc., Wilmington, OH (US)

(21) Appl. No.: 11/667,368

(22) PCT Filed: Nov. 9, 2005
(86) PCT No.: PCT/US2005/040600

§ 371 Date: Nov. 14, 2007

Related U.S. Application Data
(60) Provisional application No. 60/626,562, filed on Nov. 10, 2004.

(51) Int. Cl. B65D 25/22; B60R 9/00

(52) U.S. Cl. 220/737; 224/407

(57) ABSTRACT

A portable container holder for a pressurized gas container comprises a support frame configured to at least partially abut a side portion of a pressurized gas container. The portable container holder further comprises a storage compartment attached to the support frame, and configured to support at least a bottom portion of a pressurized gas container. The portable container holder also comprises an extendable mechanical linkage attached to the support frame, and configured to releasably couple the portable container holder with patient transporters of various sizes through a compressive force.

This invention relates to pressurized gas cylinder holders, and more particularly, to a portable oxygen bottle holder of the type described herein, which is suitable for coupling with various types of patient transporters, and which is resiliently supported to the frames of these devices.

In emergency situations, rescue or other emergency services generally store portable oxygen bottles for patient use in cabinets on emergency vehicles either loosely or on some form of mechanical linkage. When the oxygen bottle is needed, the bottle is lifted out of the cabinet or removed from the linkage, and carried to patient. Typically, when transporting the patient away from the scene, the oxygen bottle is then placed loosely on the transporter next to the patient or secured in another mechanical linkage provided on the transporter. Obviously, the arrangement in which the oxygen bottle is carried loosely is undesirable. Placing the oxygen bottle in another mechanical linkage provided on the transporter at the scene requires extra time and usually requires assistance, which is also undesirable.

Additionally, many patients have breathing disorders that necessitate the use of oxygen. In certain extreme cases, the patient must have oxygen for breathing available at all times, and thus must have an oxygen bottle present at all times. Typically, the prior art addressing the transportation of cylinders in such situations centers on the coupling of a cylinder to one specific device.

For example, U.S. Pat. No. 6,672,321 relates to an apparatus for supporting an oxygen bottle on a walker. The oxygen bottle is suspended from the top cross member inside a canvas bag. The bottle is oriented in the upright position. The apparatus also includes stabilizers which keep the bottle secured and centered on the cross members of the walker.

For example, U.S. Pat. No. 4,213,648 relates to a wheelchair having a rigid support frame for supporting an oxygen bottle thereon. The support frame includes a holding device having a hollow cylinder with an open top and a closed bottom. The cylinder includes a mounting bracket for releasably attaching the cylinder to the spaced upwardly extending pins on the wheelchair frame conventionally used to mount detachable foot rests.

U.S. Pat. No. 4,506,903 relates to a device for detachably coupling an oxygen bottle cart to a wheelchair such that the cart and the chair are transportable together as a unit without the need of a separate operator for the cart.

U.S. Pat. No. 4,696,420 relates to a device for detachably coupling a rigid oxygen bottle carrier to a wheelchair, wherein the device fits between the downwardly directed support arms of the wheelchair with the carrier being made in different lengths, depending on the size of the chair.

U.S. Pat. No. 4,431,206 teaches an accessory carrier for oxygen bottles, intravenous containers and other medical accessories and to this extent includes a lower vertically extending post for detachable attachment to the back of a wheelchair so as to permit folding of the wheelchair and further including an upper elongated vertical post for supporting additional accessories.

U.S. Pat. No. 3,970,344 teaches an oxygen bottle holding device for ready attachment to a wheelchair. The device is collapsible to the extent that it includes a tank-receiving basket and a pair of struts detachably supported on the wheelchair and pivotally connected to the sides of the basket. Flexible cable means are provided to maintain the basket in a vertical position when the device is in an operative position on the wheelchair.

It is against the above background that the present invention provides a number of advantages and advancements over the prior art. The present inventor has recognized the need for providing a pressurized container, for example, an oxygen bottle that can be conveniently moveable with multiple types of patient transporters by coupling the container to the patient transporter via a mechanical linkage.

In accordance with one embodiment, a portable container holder for a pressurized gas is provided. The portable container comprises a support frame configured to at least partially abut a side portion of a pressurized gas container, and a storage compartment attached to the support frame, and configured to support at least a bottom portion of a pressurized gas container. The portable container holder further comprises an extendable mechanical linkage attached to the support frame, and configured to releasably couple the portable container holder with patient transporters of various sizes through a compressive force.

Additional features and advantages provided by the portable container holders of the present invention will be more fully understood in view of the following detailed description.

The following detailed description of the embodiments of the present invention can be best understood when read in conjunction with the following drawings, where like structure is indicated with like reference numerals and in which:

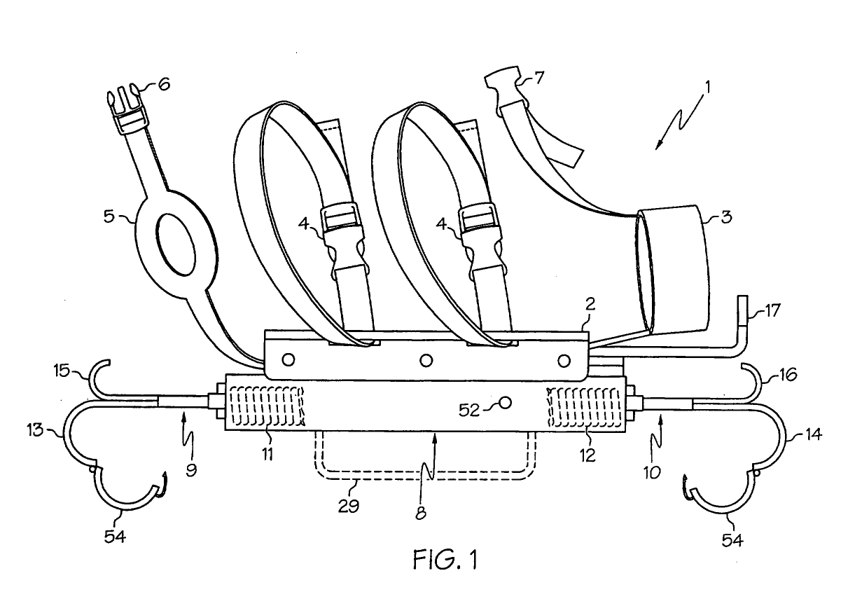

FIG. 1 is a plan view representation illustrating an holder in accordance with the invention;

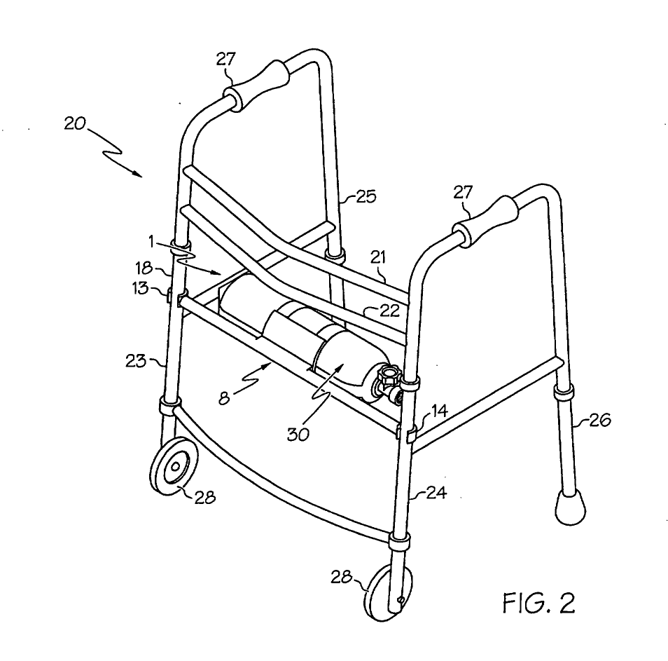

FIG. 2 is a diagrammatic representation illustrating the holder shown in FIG. 1 supported on the front of a walker;

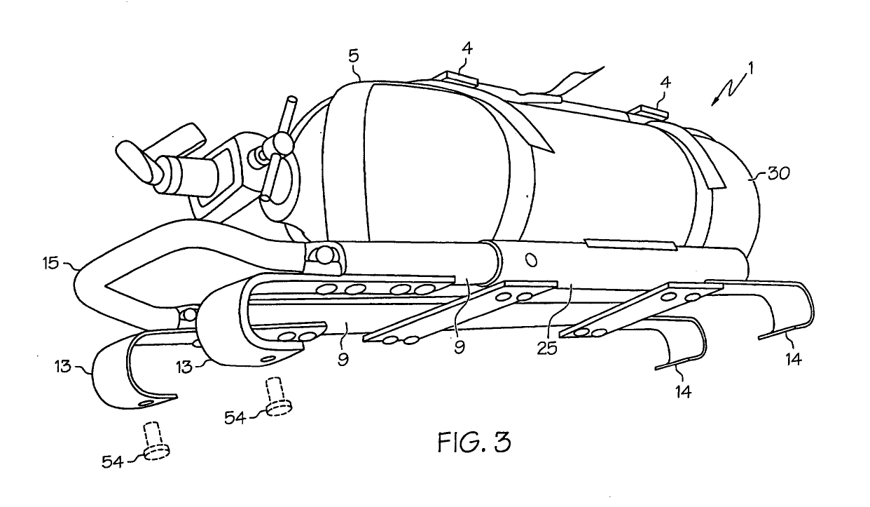

FIG. 3 is a plan view representation illustrating a further embodiment in accordance with the invention;

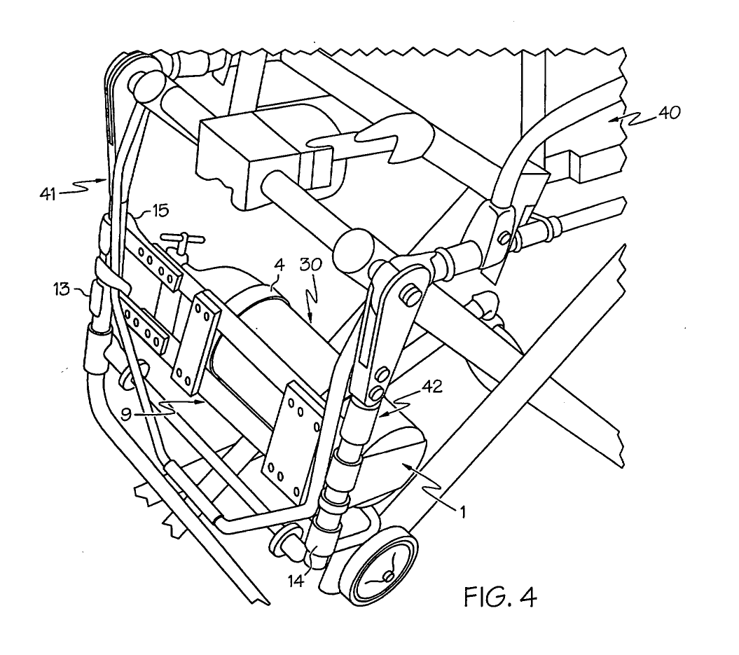

FIG. 4 is a diagrammatic representation illustrating the holder shown in FIG. 3 supported on the undercarriage of an ambulance cot.

As used herein, the term “patient transporter” refers to stair chairs, stretcher trolleys, cots, stretchers, walkers, strollers, and wheelchairs. It is also to be appreciated that the present invention may be also suitable for use with ambulatory aids such as walkers and rollators, and equipment transporters such as carts, dollies, back pack frames, and the like.

FIG. 1 illustrates one embodiment of a portable oxygen bottle holder according to the present invention, which is generally referenced as 1. In this embodiment, extending outward from a frame 2 is an expandable pouch 3 to secure the bottom portion of an oxygen bottle (not shown). The pouch 3 or a metal lip 17 can be used interchangeably as a support for the bottom of the oxygen bottle. In further exemplary embodiments, the bottle holder 1 may also comprise two straps 4 to secure the oxygen bottle to the frame 2, and a fabric loop 5 which the top of the oxygen bottle extends through. The straps 4 comprise a fabric or flexible material, which extend in opposite directions from opposite sides of the support frame 2. The straps 4 wrap around the oxygen bottle, and are tightened to firmly secure the oxygen bottle against the support frame 2. In another embodiment, the fabric loop 5 contains a buckle member 6, which connects to a pouch strap 7 to secure the bottle from the top and bottom. The top of the oxygen bottle may extend through the fabric loop 5. The combination of the straps 4, pouch 3, and fabric loop 5 may prevent the oxygen bottle from sliding in a horizontal or vertical direction. The pouch and straps are made from flexible materials, and the loops are of different sizes, whereby different size oxygen bottles may be accommodated. The invention further allows the oxygen bottle to be supported away from the center of the patient transporter back so as not to interfere with the use of the patient transporter.

The portable container holder further comprises an extendable mechanical linkage attached to the support frame, and configured to releasably couple the portable container holder with patient transporters of various sizes through a compressive force. In one embodiment, the mechanical linkage is a cylindrical housing 8 located on the non-bottle side of the frame 2, which contains two spring loaded opposing rods 9 and 10 that are connected to the cylindrical housing 8 through springs 11 and 12. The rods 9 and 10 may contain at least one latching mechanism, like a hook 13 and 14, on the outward extending portions of the rods 9 and 10, whereby the hooks are used to couple the oxygen bottle and oxygen bottle holder to the patient transporter. Because the rods 9 and 10 are connected to the metal frame of the bottle holder by opposing springs, the length of the rods may be extended to accommodate many different patient transporter sizes. The rods 9 and 10 comprised hooks 13 and 14, respectively, for coupling with a patient transporter. Rods 9 and 10 may both be extended in opposite directions by pulling on handles 15 and 16, until the hooks have been attached to the patient transporter. The holder 1 is held to the frame of the patient transport under spring tension. In a further embodiment of the invention, the spring constants of the springs may be optimized to ensure that the oxygen bottle stays properly centered on the patient transporter. For example, in one embodiment, spring 11 may have about a 2 to 1 mechanical advantage over spring 12 to provide automatic centering. Additionally, a securing mechanism 52, such as for example, and not to be limited by, a locking pin, release tab, or screw knob, may be provide to releasable lock at least one the rods 9 or 10 in their extended position. Furthermore, an optional handle 29 may be provided to the holder 1, if desired. Moreover, hooks 13 and 14 may be provided each with a locking device 54 such as for example, and not to be limited by, a spring biased clamping portion, a spring biased locking pin, release tab, or screw knob, in order to make the holder 1 mount more permanently or fast to a patient transporter.

Turning now to FIG. 2, there is illustrated the oxygen bottle holder 1, containing an oxygen bottle 30, and coupled to a walker, generally referenced 20, that embodies the teachings of the present invention. The walker is of typical construction and includes a pair of side frames 18 and 19. Side frames 18 and 19 are of similar construction and includes vertically disposed front legs labeled 23 and 24 respectively and vertically disposed rear legs labeled 25 and 26. A horizontally disposed handrail 27 is integrally joined to the front and rear legs and provides a means by which a patient can securely grip and control the walker when situated between the two side frames. The two side frames are supported in a spaced apart relationship by an upper cross member 21 and a lower cross member 22 which are secured between the two front legs of the frame. The rear section of the walker remains open so that a patient using the walker can pass in an unobstructed manner between the two side frames.

Each of the side frames is equipped with wheels 28 that are mounted in the lower part of the front legs 23 and 24. As shown, the bottle holder rods 9 and 10 extend, and are connected to the front legs 23 and 24, respectively, by hooks 13 and 14, respectively, wherein hook 13 connects to front leg 23, and hook 14 connects to side frame 24. Because of the flexibility of the spring loaded rods, the bottle holder is also capable of being attached to the side of the walker in addition to the front by coupling the oxygen bottle holder to either of the sets of front and back legs. These configurations will enable the patient to use the walker and receive oxygen, without interfering with the use of the walker, or making the walker unstable. After coupling, a further embodiment of the invention may include the insertion of pins into the rods to prevent the rods from sliding, thereby providing additional stability.

FIG. 3 illustrates another embodiment of the present invention, in which there are two pairs of hooks, labeled 13 and 14, on each side of the bottle holder, and two spring loaded cylindrical rods 9. However, in this embodiment, the rods 9 only extend in one direction upon pulling the handle 15, and the second pair of hooks 14 are stationary.

FIG. 4 illustrates how the embodiment of FIG. 3 is coupled to an ambulance cot 40. Ambulance cots of the roll-in type are used to support a patient on a stretcher, the stretcher being mounted (fixedly or removably) on a wheeled undercarriage or transporter. Emergency cots of the roll-in type are configured to be able to be rolled into various types of rescue vehicles, such as ambulances, vans, station wagons, modular type rescue vehicles, aircrafts, helicopters and the like. In order to be able to roll the cot into such a vehicle, the cot generally is configured to raise at least its loading end to a similar height to that of the platform in the emergency vehicle upon which the patient is to be transported. With loading wheels supported on the platform of the emergency vehicle, the undercarriage or transporter of the cot is then collapsed, and the entire cot is rolled into the vehicle to be supported on the platform.

The present invention may be coupled to the cot in all of the above listed cot configurations. For example, the oxygen bottle holder 1 may be coupled by attaching the bottle holder to side legs 41 and 42. First, the stationary hooks 14 are coupled to side frame 42. Then, the handle 15 is pulled extending the rods 9 until the hooks 13 may be attached to side frame 41. FIG. 4 illustrates the coupling of the oxygen bottle holder 1 to the underside of the cot, thus the bottle holder and bottle carried thereby does not affect the functionality of maneuverability of the cot.

The invention as described herein has several advantages over prior art holders for use with patient transporters, as will be readily discerned. For example, the present invention provides an oxygen bottle that can be conveniently moved in a portable holder when a patient is being moved in a transporter, whether a wheelchair, an ambulance cot, or a walker. Additionally, the embodiments described in FIGS. 1 and 3 can be used interchangeably in the patient transporters described in FIGS. 2 and 4 or any other patient transporters described above.

Moreover, in one embodiment the portable oxygen bottle holder of the invention is made of lightweight metal, such as aluminum or titanium, and flexible materials. Such a focus on providing a low weighing device is particularly useful to the disabled. In this regard, it will be understood that pouch 3, the straps 4, and the fabric loops 5 heretofore described are formed from a suitable flexible fabric material such as a heavy duty waterproof Nylon.

In addition, the spring loaded rods 9 enable the bottle holder to accommodate multiple sizes of patient transporters, and multiple coupling configurations for these transporters. The oxygen bottle holder may be oriented vertically and horizontally with both orientations being highly stable. Because of the flexibility in orientation, these oxygen bottle holders enable the patient to receive oxygen without sacrificing the functionality and stability of the patient transporter.

It is noted that terms like “specifically,” “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention. It is also noted that terms like “substantially” and “about” are utilized herein to represent the inherent degree of uncertainty that may be attributed to any quantitative comparison, value, measurement, or other representation.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

1. A portable container holder for a pressurized gas container comprising:
a support frame configured to at least partially abut a side portion of a pressurized gas container;
a storage compartment attached to the support frame, and configured to support at least a bottom portion of a pressurized gas container; and
an extendable mechanical linkage attached to the support frame, and configured to releasably couple the portable container holder with patient transporters of various sizes through a compressive force.

2. A portable container holder according to claim 1 wherein the mechanical linkage is configured to horizontally or vertically couple a pressurized container to a patient transporter.

3. A portable container holder according to claim 1 wherein the pressurized gas container is a cylindrical pressurized oxygen bottle.

4. A portable container holder according to claim 1 wherein the storage compartment comprises a pouch, a metal lip, or combinations thereof.

5. A portable container holder according to claim 4 wherein the pouch is a flexible material configured to accommodate various sizes of pressurized gas containers.

6. A portable container holder according to claim 1 further comprising at least one adjustable strap operable to secure a pressurized container inside the storage compartment.

7. A portable container holder according to claim 1 further comprising a top support member operable to secure a pressurized container at a top portion of the container.

8. A portable container holder according to claim 7 wherein the top support member comprises a fabric loop configured to receive at least a top portion of a pressurized container.

9. A portable container holder according to claim 7 wherein the top support member comprises a buckle member.

10. A portable container holder according to claim 7 further comprising at least one additional adjustable strap configured to secure a pressurized container from top to bottom.

11. A portable container holder according to claim 10 wherein the support frame comprises a metal, a rigid polymer, or combinations thereof.

12. A portable container holder according to claim 11 wherein the metal comprises titanium, aluminum, or combinations thereof.

13. A portable container holder according to claim 1 wherein the mechanical linkage comprises at least one hook configured to attach the pressurized container holder to a patient transporter.

14. A portable container holder according to claim 1 wherein the mechanical linkage comprises at least one extendable spring loaded rod configured to secure the pressurized container holder to a patient transporter.

15. A portable container holder according to claim 14 wherein the mechanical linkage comprises two spring loaded rods extending in opposite directions

16. A portable container holder according to claim 15 wherein the spring tension of one rod spring defines a 2 to 1 mechanical advantage over the spring tension of the other rod spring.

17. A portable container holder according to claim 1 wherein the mechanical linkage comprises a locking mechanism configured to releasably lock the mechanical linkage in an extended position

18. A portable container holder according to claim 1 further comprising a handle.
